(19) United States
(12) Patent Application Publication
(10) Pub. No.: US 2025/0325015 A1
(43) Pub. Date: Oct. 23, 2025

(54) FULL-NUTRITION FORMULA FOOD EMULSION FOR SPECIAL MEDICAL PURPOSE WITH VEGETABLE COMPLETE PROTEIN AS SOLE PROTEIN SOURCE AND PREPARATION METHOD THEREFOR

(71) Applicant: SOUTH CHINA UNIVERSITY OF TECHNOLOGY, Guangzhou (CN)

(72) Inventors: Zhili WAN, Guangzhou (CN); Yunyi YANG, Guangzhou (CN); Xiaoquan YANG, Guangzhou (CN)

(73) Assignee: SOUTH CHINA UNIVERSITY OF TECHNOLOGY, Guangzhou (CN)

(21) Appl. No.: 18/870,389

(22) PCT Filed: May 23, 2023
(86) PCT No.: PCT/CN2023/095692

§ 371 Date: Nov. 28, 2024

(30) Foreign Application Priority Data
Aug. 15, 2022 (CN) 202210977861.X

(51) Int. Cl. A23L 33/00; A23L 33/115; A23L 33/185

(52) U.S. Cl. CPC A23L 33/40; A23L 33/115; A23L 33/185

(57) ABSTRACT

A full-nutrition formula food emulsion for special medical purpose with a vegetable complete protein as sole protein source, comprising complete protein from plant sources including soy protein, fat, linoleic acid, α-linolenic acid, carbohydrate, dietary fiber, vitamins, and mineral elements, wherein the carbohydrate comprises one or more of small molecule pectin, sodium alginate, CMC, λ-carrageenan, guar gum, and xanthan gum anionic polysaccharide.

### TECHNICAL FIELD

The present invention belongs to the technical field of special medical food, and specifically relates to a full-nutrition special medical food emulsion with a vegetable complete protein as sole protein source and a preparation method therefor.

### BACKGROUND

Formula food for special medical purpose (referred to as special medical food) refers to formula food specially processed and formulated to meet the special needs of people with limited feeding, digestion and absorption disorders, metabolic disorders, or specific disease states for nutrients or meals. As a key component of nutritional support, the special medical food has important effects of improving a treatment and rehabilitation effect, shortening a course of disease, reducing medical costs and decreasing a readmission rate in clinical treatment. Full-nutrition special medical food is a mainstream development direction of special medical food in China at present, and emulsion products can be not only eaten directly but also used by tube feeding without brewing, are convenient for clinical application, and have a higher market utilization rate and high product demands.

Full-nutrition special medical food emulsion systems simultaneously have a large number of proteins and abundant minerals, and the contact between mineral ions (such as calcium ions, magnesium ions, zinc ions, copper ions, etc.) and proteins will greatly affect properties of the proteins, leading to instability phenomena, such as flocculation, creaming and coalescence, of emulsions. Currently, a most commonly used method includes using micellar proteins (such as casein and hydrolyzed peptides) (e.g., a Chinese Invention Patent Application, publication No. CN106579345A) to embed mineral ions, so as to avoid the contact between complete proteins and mineral ions. More commonly used hydrolyzed peptides have the problems of complex processes, complicated and uncontrollable enzymolysis processes, odorous products and poor emulsification stability, and generated active peptides have the safety problems of pathogenicity and allergenicity to the human body and have great potential safety hazards to people with low immunity.

Vegetable proteins have natural sources and high safety and are green and environmentally friendly, which are more in line with a natural and sustainable development direction of the modern food industry. Soybean proteins having high contents of essential amino acids are vegetable complete proteins, and can be used as high-quality protein sources for the special medical food to meet the needs for plant-based specific medical food. However, due to the above problem that complete proteins are sensitive to mineral ions, full-nutrition special medical food emulsion products with a vegetable complete protein as sole protein source are still not found on the market at present.

### SUMMARY

The present invention provides a preparation method for a full-nutrition special medical food emulsion with a vegetable complete protein as sole protein source. By adjusting the ratio of anionic polysaccharides to mineral ions and optimizing a preparation process, a colloidal mineral is formed, which effectively solves the problem of instability caused by direct contact between a bean protein emulsion and various mineral ions and achieves uniform dispersion of minerals in a vegetable protein-based special medical emulsion system. On such basis, a full-nutrition special medical emulsion with uniform appearance, high thermal stability and storage stability is prepared, which fills the product blank of full-nutrition special medical emulsion food with a vegetable complete protein as sole protein source.

The present invention adopts the following technical solutions.

In a first aspect of the present invention, a full-nutrition special medical food emulsion with a vegetable complete protein as sole protein source is provided. According to requirements of the General Rules for Formula Food for Special Medical Purpose (GB 29922-2013), the emulsion includes the following components:

| Nutritional component | Per 100 mL | Nutritional component | Per 100 mL |
|---|---|---|---|
| Protein (g) | 2-8 | Pantothenic acid (mg) | 0.175-3 |
| Fat (g) | 2-12 | Vitamin C (mg) | 3.25-45 |
| Linoleic acid (g) | 0.4-2 | Biotin (μg) | 1.25-6 |
| α-linolenic acid (g) | 0.02-1 | Sodium (mg) | 50-300 |
| Carbohydrate (g) | 5-20 | Potassium (mg) | 67.5-350 |
| Dietary fiber (g) | 0.5-8 | Copper (μg) | 27.5-300 |
| Vitamin A (μg RE) | 23.5-269 | Magnesium (mg) | 11-150 |
| Vitamin D (μg) | 0.475-3.75 | Iron (mg) | 0.5-2.75 |
| Vitamin E (mg α-TE) | 0.475-2.5 | Zinc (mg) | 0.25-2.5 |
| Vitamin K₁ (μg) | 2.625-5 | Manganese (μg) | 15-600 |
| Vitamin B₁ (mg) | 0.05-1 | Calcium (mg) | 32.5-150 |
| Vitamin B₂ (mg) | 0.05-1 | Phosphorus (mg) | 24-100 |
| Vitamin B₆ (mg) | 0.05-1 | Iodine (μg) | 4-60 |
| Vitamin B₁₂ (μg) | 0.075-1.5 | Chlorine (mg) | 1-260 |
| Nicotinic acid (mg) | 0.125-2 | Selenium (μg) | 2-26.5 |
| Folic acid (μg) | 13.25-50 | | |

Preferably, the protein is a vegetable-derived complete protein and includes one or more of a soybean protein, a mung bean protein, a pea protein, a red bean protein, a chickpea protein, a broad bean protein, and other bean proteins, wherein the soybean protein is a complete protein, is an essential addition component, and may be composed of one or two of a soybean protein isolate and a soybean protein concentrate.

Preferably, the fat is composed of one or more selected from medium chain triglyceride (MCT), sunflower seed oil, soybean oil, rapeseed oil, corn oil, olive oil, peanut oil, camellia oil, rice bran oil, sesame oil, cottonseed oil, walnut oil, fish oil, krill oil, algae oil, linseed oil, perilla seed oil, chia seed oil, diacylglycerol oil, and other edible oils.

Preferably, the carbohydrate includes one or more of glucose, sucrose, oligosaccharide, polysaccharide, and dietary fiber, wherein one or more of small molecule pectin, sodium alginate, CMC, A-carrageenan, guar gum, xanthan gum, and other anionic polysaccharides are essential addition components.

Preferably, the minerals are present in the form of inorganic salts and/or (including “and” as well as “or” two conditions) organic salts.

The emulsion in the present invention has the following characteristics:
(1) the appearance is uniform and milky white, the fluidity is good, and no obvious creaming, caking and foreign matter are found;
(2) according to determination by a particle size analyzer, a particle size of oil drops of the emulsion is less than 1 μm;
(3) according to determination by a potentiometer, an absolute potential value of the emulsion is greater than 20 m V;
(4) according to determination by a rheometer, an apparent viscosity of the emulsion is less than 200 mPa·s; and
(5) after storage at 30° C. for 6 months, the appearance, particle size and rheological data of the emulsion all remain stable.

In a second aspect of the present invention, a preparation method for the full-nutrition special medical food emulsion with a vegetable complete protein as sole protein source is provided, including the following steps:
dispersing a carbohydrate in water, performing homogenization after adding minerals, and sequentially adding a vegetable protein and water-soluble vitamins to obtain an aqueous phase, during which the pH of a solution is constantly neutral; mixing oil-soluble vitamins with fat to obtain an oil phase; and mixing the aqueous phase with the oil phase, followed by emulsification and sterilization to obtain the full-nutrition special medical food emulsion; wherein the minerals include sodium, potassium, copper, magnesium, iron, zinc, manganese, calcium, phosphorus, iodine, chlorine, and selenium; the oil-soluble vitamins include vitamin A, vitamin D, vitamin E, and vitamin K₁; and the water-soluble vitamins include vitamin B₁, vitamin B₂, vitamin B₆, vitamin B₁₂, nicotinic acid, folic acid, pantothenic acid, vitamin C, and biotin.

Preferably, oil-soluble vitamin powders are added after the fat is evenly mixed in the steps, a part of materials may be heated in an auxiliary water bath when being difficult to dissolve, a heating temperature is not higher than 60° C., and a heating time is not longer than 20 min.

Preferably, mixing of various premixed solutions in the steps is performed in a certain sequence.

Preferably, a pH regulation solution used to maintain the pH of the system includes one or more of edible organic or inorganic acids and salts thereof.

Preferably, the homogenization in the steps is performed by one or more methods of shearing homogenization, ultrasonic homogenization, high-pressure homogenization, and ball milling.

Preferably, the emulsification in the steps is performed by one or more methods of shearing homogenization, ultrasonic homogenization, and high-pressure homogenization.

Preferably, the sterilization in the steps includes high-temperature instantaneous sterilization, pasteurization, and other processes of ensuring the safety and stability of food.

Preferably, the pH of the aqueous phase in the steps is adjusted to 6.5-7.5 to avoid the flocculation of protein, and the pH regulation solution used to maintain the pH of the system at neutral includes one or more of edible organic or inorganic acids and salts thereof.

The special medical emulsion of the present invention has uniform and milky white appearance, good fluidity, and no obvious creaming, caking and foreign matter; the apparent viscosity of the emulsion is less than 200 mPa·s; the particle size of oil drops of the emulsion is less than 1 μm; the absolute potential value is greater than 20 mV; and after storage at 30° C. for 6 months, the appearance and various physical and chemical indexes have no obvious abnormal changes.

Compared with the prior art, the present invention has the following advantages and beneficial effects:
1. The present invention provides a preparation method for a full-nutrition special medical food emulsion with a vegetable complete protein as sole protein source. By adding the anionic polysaccharides and regulating the preparation process, the problem of instability of the emulsion caused by sensitivity of the vegetable protein in the special medical emulsion to mineral ions is solved. The emulsion has no need to additionally add protein peptides and the like to stabilize mineral ions, which avoids product odors and health risks caused by the protein peptides and the like, provides a simpler and safer nutrition strategy for preparation of the full-nutrition special medical emulsion, and also provides a technical solution for application of the vegetable complete protein in the full-nutrition special medical emulsion.
2. Any sources of animal proteins are not used in the present invention, and the pursuit of target population for “sustainability”, “clean label” and other properties of food can be met. The process is simple and mild, low-carbon and sustainable, and suitable for large-scale production and application.
3. Nutritional demands are ensured through comprehensive and balanced design. Nutrient standards of the present invention are formulated according to the National Food Safety Standard: General Rules for Formula Food for Special Medical Purpose, the Dietary Reference Intakes for Chinese Residents (DRIS), and other national and international standards.

### BRIEF DESCRIPTION OF DRAWINGS

FIG. 1 shows the appearance of full-nutrition special medical food emulsions after sterilization in Embodiment 1.

FIG. 2 shows the appearance of full-nutrition special medical food emulsions after sterilization in Embodiment 2.

FIG. 3 shows the upright and lateral appearance of full-nutrition special medical food emulsions after sterilization of sample 2(a) and sample 8(b) in Embodiment 4.

FIG. 4a shows the appearance of a sample in Embodiment 6.

FIG. 4b shows the viscosity of the sample in Embodiment 6.

FIG. 4c shows the particle size of the sample in Embodiment 6.

FIG. 4d shows potential data of the sample in Embodiment 6.

### DETAILED DESCRIPTION OF EMBODIMENTS

In order to make the technical problems to be solved by the present invention, technical solutions and beneficial effects more clearly understood, the present invention is further described in detail below in combination with embodiments. It should be understood that the specific embodiments described herein are only used to explain the present invention, rather than to limit the present invention.

In the following embodiments, determination methods of physical and chemical properties of emulsions are as follows:

Determination of apparent viscosity: An RS600HAKKE rheometer was used for determination. Changes of the apparent viscosity of samples were recorded at a shearing scanning mode (shearing rate: 0.01-100 s⁻¹), and a plate with a diameter of 60 mm was selected for testing at a gap of 0.052 mm and a test temperature of 25° C.

Determination of the particle size of emulsions: A Mastersizer 3000 micron particle size analyzer was used for determination. Setting of parameters: A refractive index of a dispersed phase (oil phase) was 1.5, and an absorption rate was 0.001; a refractive index of a continuous phase was 1.333; and a test temperature was 25° C.

Determination of the potential of emulsions: A Nano-ZS nanoparticle size and zeta potential analyzer was used for determination. After emulsions were properly diluted, the zeta potential of the emulsions was determined. Setting of parameters: A refractive index of a dispersed phase (oil phase) was 1.5, and an absorption rate was 0.001; a refractive index of a continuous phase was 1.333; and a test temperature was 25° C.

The present invention relates to a full-nutrition special medical food emulsion with a vegetable complete protein as a matrix, which includes the following nutrients per 100 mL:

TABLE 1
Nutritional component table of a full-
nutrition special medical food emulsion

| Nutritional | Per 100 mL | Nutritional | Per 100 mL |
|---|---|---|---|
| Protein (g) | 3.6 | Pantothenic acid | 0.64 |
| Fat (g) | 3.6 | Vitamin C (mg) | 12 |
| Linoleic acid (mg) | 542.8 | Biotin (μg) | 4.8 |
| α-linolenic acid | 108.6 | Sodium (mg) | 111.6 |
| Carbohydrate (g) | 12 | Potassium (mg) | 165.6 |
| Dietary fiber (g) | 5.4 | Copper (μg) | 104 |
| Vitamin A (μg RE) | 61.2 | Magnesium (mg) | 24 |
| Vitamin D (μg) | 1.15 | Iron (mg) | 1.68 |
| Vitamin E (mg α- | 1.56 | Zinc (mg) | 0.9 |
| Vitamin K₁ (μg) | 6.36 | Manganese (μg) | 300 |
| Vitamin B₁ (mg) | 0.20 | Calcium (mg) | 72 |
| Vitamin B₂ (mg) | 0.24 | Phosphorus (mg) | 56.4 |
| Vitamin B₆ (mg) | 0.20 | Iodine (μg) | 12 |
| Vitamin B₁₂ (μg) | 0.25 | Chlorine (mg) | 150 |
| Nicotinic acid (mg) | 1.08 | Selenium (μg) | 6.36 |
| Folic acid (μg) | 32.4 | | |

### Embodiment 1: Full-Nutrition Special Medical Food Emulsions Prepared by a Traditional Method

Full-nutrition special medical food emulsions were prepared according to Table 1. Specific formulas of a protein, fat and a carbohydrate are shown in Table 2. Specifically, the protein, the carbohydrate (including dietary fiber), water-soluble vitamins, minerals and other water-soluble substances were sequentially added to water for mixing for 1.5 h, during which the pH of the system was always 7.0. Oil-soluble vitamins were dispersed in the fat for mixing for 0.2 h. Then, the two solutions were mixed, followed by emulsification (50 MPa, 3 times) and sterilization (121° C., 15 min) to obtain full-nutrition special medical food emulsions with different proteins as a matrix.

TABLE 2
Formulas in Embodiment 1 (unit: g/100 mL)

| Sample | 1 | 2 |
|---|---|---|
| Protein | Casein 4 | Soybean protein isolate 4 |
| Fat | MCT (medium chain | MCT 1.5 |
| | triglyceride) 1.5 | Rapeseed oil 1.3 |
| | Rapeseed oil 1.3 | Sunflower seed oil 0.8 |
| | Sunflower seed oil 0.8 | |
| Carbohydrate | Sodium alginate 0.1 | Sodium alginate 0.1 |
| | Small molecule pectin 0.3 | Small molecule pectin 0.3 |
| | Fructooligosaccharide 5 | Fructooligosaccharide 5 |
| | Maltodextrin 6.6 | Maltodextrin 6.6 |

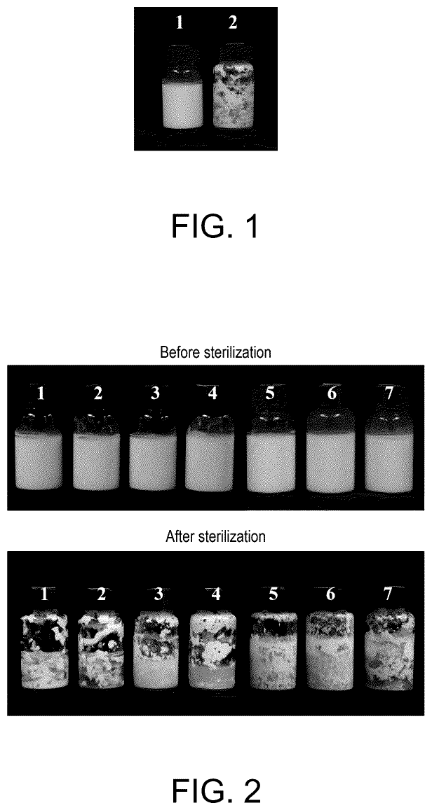

As shown in FIG. 1, the full-nutrition special medical food emulsion prepared from casein has milky white and uniform appearance, no caking or precipitation that is visible to the naked eyes, and good fluidity. The full-nutrition special medical food emulsion prepared from a soybean protein has the serious phenomena of flocculation and system collapse, indicating that soybean protein-based full-nutrition special medical food emulsion products with uniform appearance and good fluidity cannot be prepared by a traditional emulsion preparation method.

### Embodiment 2: Full-Nutrition Special Medical Food Emulsions Prepared by a Two-Step Method

Soybean protein-based full-nutrition special medical food emulsions were prepared by a two-step method. Formulas are the same as those in Table 1 and Table 2 (sample 2). Specific formulation steps are as follows.

A soybean protein isolate and a part of water-soluble substances were first added to water for dispersion at 500 rpm for 1.5 h. Then, oil-soluble substances were added for emulsification (50 MPa, 3 times) to prepare an emulsion, and remaining materials were added to the emulsion for dispersion at 500 rpm for 0.5 h, during which the pH of the system was constantly maintained at 7.0. Sterilization (121° C., 15 min) was performed to obtain a final product. Material addition sequences of various samples are as shown in Table 3.

TABLE 3
Material addition sequences for preparation of full-nutrition
special medical food emulsions by a multi-step method

| Sample | 1 | 2 | 3 | 4 |
|---|---|---|---|---|
| Before | Protein | Protein | Protein | Protein |
| emulsification | Fat, oil-soluble | Carbohydrate | Water-soluble | Minerals |
| homogenization | vitamins | Fat, oil-soluble | vitamins | Fat, oil-soluble |
| | | vitamins | Fat, oil-soluble | vitamins |
| | | | vitamins | |
| After | Carbohydrate | Minerals | Carbohydrate | Carbohydrate |
| emulsification | Minerals | Water-soluble | Minerals | Water-soluble |
| homogenization | Water-soluble | vitamins | | vitamins |
| | vitamins | | | |

| Sample | 5 | 6 | 7 |
|---|---|---|---|
| Before | Protein | Protein | Protein |
| emulsification | Carbohydrate | Carbohydrate | Minerals |
| homogenization | Minerals | Water-soluble | Water-soluble |
| | Fat, oil-soluble | vitamins | vitamins |
| | vitamins | Fat, oil-soluble | Fat, oil-soluble |
| | | vitamins | vitamins |
| After | Water-soluble | Minerals | Carbohydrate |
| emulsification | vitamins | | |
| homogenization | | | |

FIG. 2 shows the appearance of the emulsions prepared by the above formulation method before and after sterilization. Before sterilization, all the emulsions have uniform appearance and good fluidity without instability phenomena, such as flocculation and precipitation, that are visible to the naked eyes. However, after sterilization, structures of the emulsions are greatly affected, and all the samples have serious instability phenomena, indicating that stable soybean protein-based full-nutrition special medical food emulsions cannot be prepared by simply regulating the material addition sequences.

### Embodiment 3: Effect of Polysaccharide on Full-Nutrition Special Medical Food Emulsions

A carbohydrate was added to 96.4 mL of water and stirred at a rotation speed of 500 rpm for 1 h to make the carbohydrate completely dissolved, and minerals were added, evenly stirred and subjected to ultrasonic treatment (200 W) for 5 min to obtain a colloidal mineral. 4 g of a soybean protein isolate was added and stirred at 500 rpm for 1.5 h to make the protein fully dispersed, and then water-soluble vitamins were slowly added, during which the pH of the system was constantly maintained at 7.0. Oil-soluble vitamins were added to fat and stirred for dissolution, then added to the mixed aqueous solution, and subjected to shearing at 5,000 rpm for 2 min, followed by emulsification (50 MPa, 3 times) and sterilization (121° C., 15 min) to obtain a full-nutrition special medical food emulsion. Formulas of various samples are as shown in Table 1. Specifically, the protein includes the soybean protein isolate. The fat includes 1.5 g of MCT, 1.3 g of rapeseed oil, and 0.8 g of sunflower seed oil. The carbohydrate is composed of fructooligosaccharide and polysaccharide.

The effect of single polysaccharide on full-nutrition special medical food emulsions was explored.

Carbohydrate formulas and states of various samples are as shown in Table 4.

TABLE 4
Carbohydrate formulas of samples and states of samples

| Sample | 1 | 2 | 3 | 4 | 5 | 6 |
|---|---|---|---|---|---|---|
| Fructooligosaccharide | 12 g | 50 | 6 g | 3 g | 1.7 g | 11.8 g |
| Polysaccharide | 0 g | Maltodextrin | Maltodextrin | Maltodextrin | Maltodextrin | Arabic gum |
| | | 3 g | 6 g | 9 g | 10.3 g | 0.2 g |
| State of | Serious | Serious | Serious | Serious | Serious | Serious |
| sample after | flocculation | flocculation | flocculation | flocculation | flocculation | flocculation |
| sterilization | | | | | | |

| Sample | 7 | 8 | 9 | 10 | 11 |
|---|---|---|---|---|---|
| Fructooligosaccharide | 11.6 g | 11.4 g | 11.2 g | 11.9 g | 11.8 g |
| Polysaccharide | Arabic | Arabic | Arabic | Small | Small |
| | gum 0.4 g | gum 0.6 g | gum 0.8 g | molecule | molecule |
| | | | | pectin 0.1 g | pectin 0.2 g |
| State of | Serious | Serious | Serious | Flocculation | 258 nm |
| sample after | flocculation | flocculation | flocculation | | 5 mPa · s |
| sterilization | | | | | |

| Sample | 12 | 13 | 14 | 15 | 16 |
|---|---|---|---|---|---|
| Fructooligosaccharide | 9 g | 6 g | 11.8 g | 11.5 g | 11.2 g |
| Polysaccharide | Small | Small | Soybean | Soybean | Soybean |
| | molecule | molecule | polysaccharide | polysaccharide | polysaccharide |
| | pectin 3 g | pectin 6 g | 0.2 g | 0.5 g | 0.8 g |
| State of | 261 nm | 262 nm | Serious | Serious | Serious |
| sample after | 6 mPa · s | 8 mPa · s | flocculation | flocculation | flocculation |
| sterilization | | | | | |

| Sample | 17 | 18 | 19 | 20 | 21 |
|---|---|---|---|---|---|
| Fructooligosaccharide | 11 g | 11.9 g | 11.8 g | 11.1 g | 11.0 g |
| Polysaccharide | Soybean | Sodium | Sodium | Sodium | Sodium |
| | polysaccharide | alginate 0.1 g | alginate 0.2 g | alginate 0.9 g | alginate 1 g |
| | 1 g | | | | |
| State of | Serious | Flocculation | 245 nm | 423 nm | 463 nm |
| sample after | flocculation | | 15 mPa · s | 178 mPa · s | 220 mPa · s |
| sterilization | | | | | |

| Sample | 22 | 23 | 24 | 25 | 26 |
|---|---|---|---|---|---|
| Fructooligosaccharide | 11.9 g | 11.8 g | 9.9 g | 9.8 g | 11.9 g |
| Polysaccharide | CMC | CMC | CMC | CMC | λ- |
| | 0.1 g | 0.2 g | 2.1 g | 2.2 g | carrageenan |
| | | | | | 0.1 g |
| State of | Flocculation | 251 nm | 421 nm | 436 nm | Flocculation |
| sample after | | 11 mPa · s | 188 mPa · s | 218 mPa · s | |
| sterilization | | | | | |

| Sample | 27 | 28 | 29 | 30 | 31 |
|---|---|---|---|---|---|
| Fructooligosaccharide | 11.8 g | 11.2 g | 11.1 g | 11.9 g | 11.8 g |
| Polysaccharide | λ- | λ- | λ- | Guar gum | Guar gum |
| | carrageenan | carrageenan | carrageenan | 0.1 g | 0.2 g |
| | 0.2 g | 0.8 g | 0.9 g | | |
| State of | 288 nm | 418 nm | 438 nm | Flocculation | 231 nm |
| sample after | 22 mPa · s | 193 mPa · s | 223 mPa · s | | 10 mPa · s |
| sterilization | | | | | |

| Sample | 32 | 33 | 34 | 35 | 36 |
|---|---|---|---|---|---|
| Fructooligosaccharide | 11.2 g | 11.1 g | 11.99 g | 11.95 g | 11.95 g |
| Polysaccharide | Guar gum | Guar gum | Gellan | Gellan | Gellan |
| | 0.8 g | 0.9 g | gum 0.01 g | gum 0.05 g | gum 0.1 g |
| State of | 420 nm | 450 nm | Serious | Flocculation | Flocculation |
| sample after | 188 mPa · s | 218 mPa · s | flocculation | | |
| sterilization | | | | | |

| Sample | 37 | 38 | 39 | 40 | 41 |
|---|---|---|---|---|---|
| Fructooligosaccharide | 11.85 g | 11.95 g | 11.9 g | 11.2 g | 11.1 g |
| Polysaccharide | Gellan | Xanthan | Xanthan | Xanthan | Xanthan |
| | gum 0.15 g | gum 0.05 g | gum 0.1 g | gum 0.8 g | gum 0.9 g |
| State of | Serious | Flocculation | 289 nm | 463 nm | 483 nm |
| sample after | flocculation | | 80 mPa · s | 192 mPa · s | 232 mPa · s |
| sterilization | | | | | |

Flocculation: The emulsions cannot maintain uniform appearance after heat sterilization, and have caking, precipitation and foreign matter visible in normal vision.

As shown in Table 4, when minerals and polysaccharide (small molecule pectin, sodium alginate, CMC, λ-carrageenan, guar gum, xanthan gum, etc.) are added to the system after pretreatment, the sterilized soybean protein-based full-nutrition special medical food emulsions with stable appearance, small particle size and low viscosity can be prepared. Due to the characteristic of low viscosity, the small molecule pectin has a large addition range in the system.

The effect of compound polysaccharide on full-nutrition special medical food emulsions was explored.

Carbohydrate formulas and states of various samples are as shown in Table 5.

TABLE 5
Carbohydrate formulas and states of samples

| Sample | 1 | 2 | 3 | 4 | 5 |
|---|---|---|---|---|---|
| Fructooligosaccharide | 5.5 g | 11.1 g | 11 g | 11.4 g | 11.4 g |
| Polysaccharide | Small | Small | Small | Small | Small |
| | molecule | molecule | molecule | molecule | molecule |
| | pectin 0.5 g | pectin 0.5 g | pectin 0.5 g | pectin 0.5 g | pectin 0.5 g |
| | Maltodextrin | Arabic gum | Soybean | Gellan | Sodium |
| | 6 g | 0.4 g | polysaccharide | gum 0.1 g | alginate 0.1 g |
| | | | 0.5 g | | |
| State of sample | 268 nm | 288 nm | 282 nm | 277 nm | 270 nm |
| after sterilization | 15 mPa · s | 22 mPa · s | 78 mPa · s | 33 mPa · s | 35 mPa · s |

| Sample | 6 | 7 | 8 | 9 | 10 |
|---|---|---|---|---|---|
| Fructooligosaccharide | 11.4 g | 11.4 g | 11.4 g | 11.4 g | 8.4 g |
| Polysaccharide | Small | Small | Small | Small | Small |
| | molecule | molecule | molecule | molecule | molecule |
| | pectin 0.5 g | pectin 0.5 g | pectin 0.5 g | pectin 0.5 g | pectin 0.5 g |
| | CMC 0.1 g | λ-carrageenan | Guar gum | Xanthan | Sodium |
| | | 0.1 g | 0.1 g | gum 0.1 g | alginate 0.1 g |
| | | | | | Maltodextrin |
| | | | | | 3 g |
| State of sample | 273 nm | 277 nm | 267 nm | 283 nm | 273 nm |
| after sterilization | 15 mPa · s | 16 mPa · s | 15 mPa · s | 28 mPa · s | 37 mPa · s |

| Sample | 11 | 12 | 13 |
|---|---|---|---|
| Fructooligosaccharide | 11 g | 10.9 g | 11.35 g |
| Polysaccharide | Small | Small | Small |
| | molecule | molecule | molecule |
| | pectin 0.5 g | pectin 0.5 g | pectin 0.5 g |
| | Sodium | Sodium | Sodium |
| | alginate 0.1 g | alginate 0.1 g | alginate 0.1 g |
| | Arabic | Soybean | Gellan |
| | gum 0.4 g | polysaccharide | gum 0.05 g |
| | | 0.5 g | |
| State of sample | 311 nm | 348 nm | 295 nm |
| after sterilization | 85 mPa · s | 122 mPa · s | 67 mPa · s |

As shown in Table 5, under the condition that the system is stable, the selection of polysaccharide types has diversity, which can adapt to and meet various processing requirements and product demands.

### Embodiment 4: Effect of a Mineral Homogenization Process on Full-Nutrition Special Medical Food Emulsions

A carbohydrate (6 g of maltodextrin, 5.6 g of fructooligosaccharide, 0.3 g of small molecule pectin, and 0.1 g of sodium alginate) was added to 96.4 mL of water and stirred at a rotation speed of 500 rpm for 1 h for complete dissolution, and minerals were added, evenly stirred and subjected to shearing treatment. 4 g of a soybean protein isolate was added and stirred at 500 rpm for 1.5 h to make the protein fully dispersed, and then 0.07 g of water-soluble vitamins were slowly added to obtain a mixed aqueous solution, during which the pH of the system was maintained at 7.0. 1.5 g of MCT, 1.3 g of rapeseed oil, and 0.8 g of sunflower seed oil were mixed evenly. 0.03 g of oil-soluble vitamins were added, stirred until being dissolved, then completely transferred to the aqueous solution, and subjected to shearing at 5,000 rpm for 2 min, followed by emulsification (50 MPa, 3 times) and sterilization (121° C., 15 min) to obtain a full-nutrition special medical food emulsion.

Homogenization conditions and states of various samples are as shown in Table 6.

TABLE 6
Homogenization conditions and states of samples

| Sample | 1 | 2 | 3 | 4 | 5 |
|---|---|---|---|---|---|
| Shearing | Stirring | Stirring | Stirring | Shearing | Shearing |
| method | dispersion | dispersion | dispersion | homogenization | homogenization |
| Shearing | 500 rpm, | 750 rpm, | 1,000 rpm, | 5,000 rpm, | 10,000 rpm, |
| conditions | 10 min | 10 min | 10 min | 5 min | 5 min |
| State of | Precipitation | Precipitation | Precipitation | Suspension | Suspension |
| minerals | | | | | |
| State of | Obvious | Obvious | Obvious | Uniform | Uniform |
| sample after | precipitates | precipitates | precipitates | appearance | appearance |
| sterilization | at the bottom | at the bottom | at the bottom | and no obvious | and no obvious |
| | | | | precipitates | precipitates |

| Sample | 6 | 7 | 8 | 9 | 10 |
|---|---|---|---|---|---|
| Shearing | Shearing | Ultrasonic | Ultrasonic | Ultrasonic | High-pressure |
| method | homogenization | homogenization | homogenization | homogenization | homogenization |
| Shearing | 20,000 rpm, | 100 W, 5 min | 200 W, 5 min | 400 W, 5 min | 30 MPa, 1 time |
| conditions | 5 min | | | | |
| State of | Suspension | Suspension | Suspension | Suspension | Suspension |
| minerals | | | | | |
| State of | Uniform | Uniform | Uniform | Uniform | Uniform |
| sample after | appearance | appearance | appearance | appearance | appearance |
| sterilization | and no obvious | and no obvious | and no obvious | and no obvious | and no obvious |
| | precipitates | precipitates | precipitates | precipitates | precipitates |
| Sample | 11 | 12 | 13 | 14 | 15 |
| Shearing | High-pressure | High-pressure | Ball milling | Ball milling | Ball milling |
| method | homogenization | homogenization | homogenization | homogenization | homogenization |
| Shearing | 50 MPa, 1 time | 120 MPa, 1 time | 200 r/min, | 300 r/min, | 400 r/min, |
| conditions | | | 15 min | 15 min | 15 min |
| State of | Suspension | Suspension | Suspension | Suspension | Suspension |
| minerals | | | | | |
| State of | Uniform | Uniform | Uniform | Uniform | Uniform |
| sample after | appearance | appearance | appearance | appearance | appearance |
| sterilization | and no obvious | and no obvious | and no obvious | and no obvious | and no obvious |
| | precipitates | precipitates | precipitates | precipitates | precipitates |

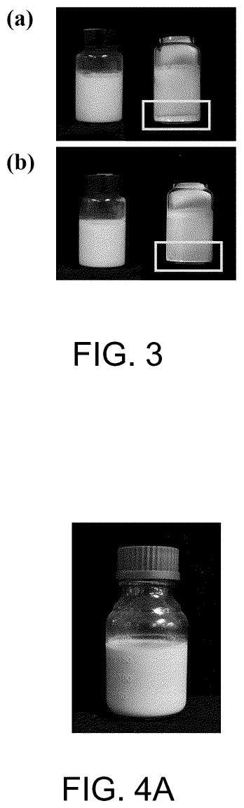

FIG. 3 shows the upright and lateral appearance of emulsions after sterilization of sample 2(a) and sample 8(b). As shown in Table 6 and FIG. 3, the full-nutrition special medical food emulsions prepared by stirring dispersion treatment of minerals (such as sample 2) do not have emulsion instability phenomena, such as flocculation, but have more precipitates. The full-nutrition special medical food emulsions obtained by homogenization treatment of minerals (such as sample 8) have no obvious precipitates and have good overall uniformity.

### Embodiment 5: Effect of the Protein Type on Full-Nutrition Special Medical Food Emulsions

A carbohydrate (6.6 g of maltodextrin, 5 g of fructooligosaccharide, 0.3 g of small molecule pectin, and 0.1 g of sodium alginate) was added to 96.4 mL of water and stirred at a rotation speed of 500 rpm for 1 h for complete dissolution, and minerals were added, evenly stirred and subjected to shearing treatment (200 W) for 5 min to obtain a colloidal mineral 4 g of a vegetable complete protein was added and stirred at 500 rpm for 1.5 h to make the protein fully dispersed, and then 0.07 g of water-soluble vitamins were slowly added to obtain a mixed aqueous solution, during which the pH of the system was maintained at 6.5-7.5. 1.5 g of MCT, 1.3 g of rapeseed oil, and 0.8 g of sunflower seed oil were mixed evenly. 0.03 g of oil-soluble vitamins were added, stirred until being dissolved, then completely transferred to the aqueous solution, and subjected to shearing at 5,000 rpm for 2 min, followed by emulsification (50 MPa, 3 times) and sterilization (121° C., 15 min) to obtain a full-nutrition special medical food emulsion.

Protein formulas and states of various samples are as shown in Table 7.

TABLE 7
Protein formulas and states of samples

| Sample | 1 | 2 | 3 | 4 | 5 |
|---|---|---|---|---|---|
| Vegetable | Soybean | Pea protein | Mung bean | Chickpea | Soybean |
| complete | protein | isolate 4 g | protein | protein | protein |
| protein | isolate 4 g | | isolate 4 g | isolate 4 g | isolate 3 g |
| | | | | | Pea protein |
| | | | | | isolate 1 g |
| State of | 268 nm | 262 nm | 231 nm | 288 nm | 262 nm |
| sample after | 15 mPa · s | 17 mPa · s | 13 mPa · s | 19 mPa · s | 15 mPa · s |
| sterilization | | | | | |

| Sample | 6 | 7 | 8 | 9 | 10 |
|---|---|---|---|---|---|
| Vegetable | Soybean | Soybean | Soybean | Soybean | Soybean |
| complete | protein | protein | protein | protein | protein |
| protein | isolate 3 g | isolate 3 g | isolate 2 g | isolate 2 g | isolate 2 g |
| | Mung bean | Chickpea | Pea protein | Pea protein | Mung bean |
| | protein | protein | isolate 1 g | isolate 1 g | protein |
| | isolate 1 g | isolate 1 g | Mung bean | Chickpea | isolate 1 g |
| | | | protein | protein | Chickpea |
| | | | isolate 1 g | isolate 1 g | protein |
| | | | | | isolate 1 g |
| State of | 260 nm | 277 nm | 265 nm | 282 nm | 280 nm |
| sample after | 15 mPa · s | 18 mPa · s | 14 mPa · s | 19 mPa · s | 18 mPa · s |
| sterilization | | | | | |

As shown in Table 7, in the system, the investigated 4 types of vegetable complete proteins can all be used for preparing stable and uniform full-nutrition special medical food emulsions, and can also achieve good effects in compound use.

### Embodiment 6: Investigation of the Stability of a Full-Nutrition Special Medical Food Emulsion

A carbohydrate (6.6 g of maltodextrin, 5 g of fructooligosaccharide, 0.3 g of small molecule pectin, and 0.1 g of sodium alginate) was added to 96.4 mL of water and stirred at a rotation speed of 500 rpm for 1 h for complete dissolution, and minerals were added, evenly stirred and subjected to shearing treatment (200 W) for 5 min to obtain a colloidal mineral. 4 g of a soybean protein isolate was added and stirred at 500 rpm for 1.5 h to make the protein fully dispersed, and then 0.07 g of water-soluble vitamins were slowly added to obtain a mixed aqueous solution, during which the pH of the system was maintained at 7.0. 1.5 g of MCT, 1.3 g of rapeseed oil, and 0.8 g of sunflower seed oil were mixed evenly. 0.03 g of oil-soluble vitamins were added, stirred until being dissolved, then completely transferred to the aqueous solution, and subjected to shearing at 5,000 rpm for 2 min, followed by emulsification (50 MPa, 3 times) and sterilization (121° C., 15 min) to obtain a full-nutrition special medical food emulsion. The emulsion was stored at 30° C. for 6 months to investigate the stability of the full-nutrition special medical food emulsion.

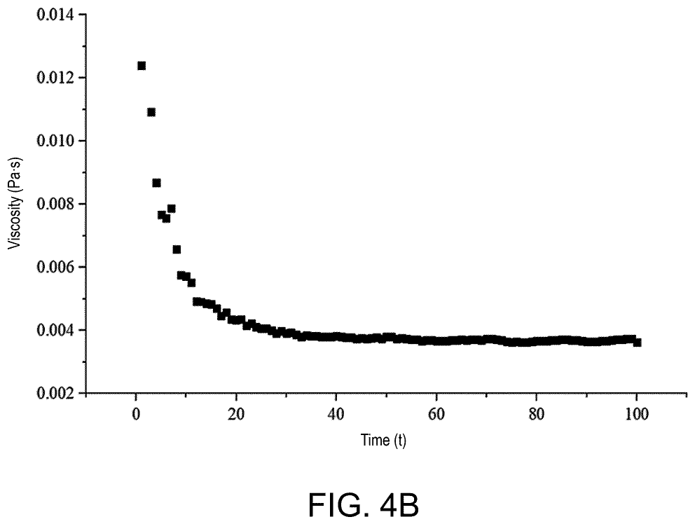

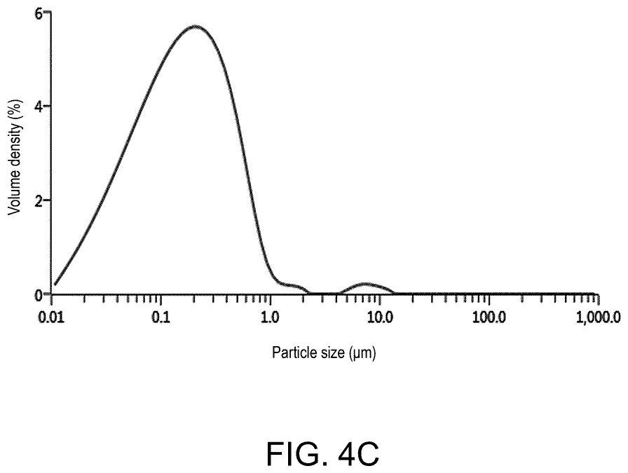

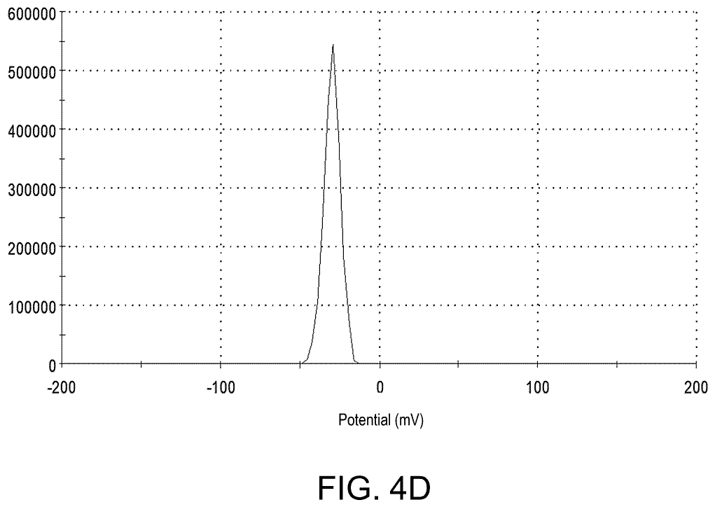

As shown in FIG. 4, the soybean protein-based full-nutrition special medical food emulsion has uniform appearance and no obvious emulsion instability phenomena, such as layering and precipitation, after storage for 6 months. Various physical and chemical data of the emulsion were further determined. Results show that the sample has an apparent viscosity of 3.2 mPa·s, a particle size of 258 nm and a potential of −30.6 mV, indicating that the emulsion has strong stability.

Calculation of energy: The emulsion per 100 mL includes 4 g of the soybean protein isolate, which is 3.6 g of protein calculated according to the protein content of 90%. The emulsion includes 1.5 g of the MCT, 1.3 g of the rapeseed oil, and 0.8 g of the sunflower seed oil, and has a total fat content of 3.6 g. The emulsion includes 6.6 g of the maltodextrin, 5 g of the fructooligosaccharide, 0.3 g of the small molecule pectin, and 0.1 g of the sodium alginate, and has a total carbohydrate content of 12 g, in which a dietary fiber (fructooligosaccharide, small molecular pectin, and sodium alginate) content is 5.4 g. According to provisions of the General Rules for Formula Food for Special Medical Purpose, a sum obtained after multiplying the contents of protein, fat and carbohydrate in the product per 100 mL by corresponding energy coefficients of 17 KJ/g, 37 KJ/g and 17 KJ/g (the energy coefficient of dietary fiber is calculated according to 50% of the energy coefficient of carbohydrate) is 353.35 KJ/100 mL, which is higher than 295 kJ specified in the General Rules for Formula Food for Special Medical Purpose.

The above embodiments are preferred embodiments of the present invention, but the embodiments of the present invention are not limited to the above embodiments. Any other changes, modifications, substitutions, combinations and simplifications that are made without deviating from the spirit, essence and principles of the present invention shall be equivalent replacement modes, which shall be included in the scope of protection of the present invention.

1. A full-nutrition formula food emulsion for special medical purpose with a vegetable complete protein as sole protein source, wherein the emulsion comprises the following nutrients per 100 mL: 2-8 g of protein, 2-12 g of fat, 0.4-2 g of linoleic acid, 0.02-1 g of α-linolenic acid, 5-20 g of carbohydrate, 0.5-8 g of dietary fiber, 23.5-269 μg RE of vitamin A, 0.475-3.75 μg of vitamin D, 0.475-2.5 mg α-TE of vitamin E, 2.625-5 μg of vitamin K₁, 0.05-1 mg of vitamin B₁, 0.05-1 mg of vitamin B₂, 0.05-1 mg of vitamin B₆, 0.075-1.5 μg of vitamin B₁₂, 0.125-2 mg of nicotinic acid, 13.25-50 μg of folic acid, 0.175-3 mg of pantothenic acid, 3.25-45 mg of vitamin C, 1.25-6 μg of biotin, 50-300 mg of sodium, 67.5-350 mg of potassium, 27.5-300 μg of copper, 11-150 mg of magnesium, 0.5-2.75 mg of iron, 0.25-2.5 mg of zinc, 15-600 μg of manganese, 32.5-150 mg of calcium, 24-100 mg of phosphorus, 4-60 μg of iodine, 1-260 mg of chlorine, and 2-26.5 μg of selenium.

2. The full-nutrition formula food emulsion for special medical purpose with a vegetable complete protein as sole protein source according to claim 1, wherein the protein is a vegetable-derived complete protein, and the protein is selected from one or more of a soybean protein, a mung bean protein, a pea protein, a red bean protein, a chickpea protein, and a broad bean protein; wherein the soybean protein is a complete protein, is an essential addition component, and is composed of one or two of a soybean protein isolate and a soybean protein concentrate; and
the fat is selected from one or more of medium chain triglyceride (MCT), sunflower seed oil, soybean oil, rapeseed oil, corn oil, olive oil, peanut oil, camellia oil, rice bran oil, sesame oil, cottonseed oil, walnut oil, fish oil, krill oil, algae oil, linseed oil, perilla seed oil, chia seed oil, and diacylglycerol oil.

3. The full-nutrition formula food emulsion for special medical purpose with a vegetable complete protein as sole protein source according to claim 1, wherein the carbohydrate comprises one or more of glucose, sucrose, oligosaccharide, polysaccharide, and dietary fiber, and one or more of small molecule pectin, sodium alginate, CMC, λ-carrageenan, guar gum, and xanthan gum anionic polysaccharide are essential addition components.

4. The full-nutrition formula food emulsion for special medical purpose with a vegetable complete protein as sole protein source according to claim 1, wherein the sodium, potassium, copper, magnesium, iron, zinc, manganese, calcium, phosphorus, iodine, chlorine, and selenium are present in the form of inorganic salts and/or organic salts.

5. The full-nutrition formula food emulsion for special medical purpose with a vegetable complete protein as sole protein source according to claim 1, wherein the emulsion has the following characteristics:
(1) the appearance is uniform and milky white, the fluidity is good, and no obvious creaming, caking and foreign matter are found;
(2) according to determination by a particle size analyzer, a particle size of oil drops of the emulsion is less than 1 μm;
(3) according to determination by a potentiometer, an absolute potential value of the emulsion is greater than 20 mV;
(4) according to determination by a rheometer, an apparent viscosity of the emulsion is less than 200 mPa·s; and
(5) after storage at 30° C. for 6 months, the appearance, particle size and rheological data of the emulsion all remain stable.

6. A preparation method for the full-nutrition formula food emulsion for special medical purpose with a vegetable complete protein as sole protein source according to claim 1, comprising the following steps:
dispersing a carbohydrate in water, performing homogenization after adding minerals, and sequentially adding a vegetable protein and water-soluble vitamins to obtain an aqueous phase, during which the pH of a solution is constantly neutral; mixing oil-soluble vitamins with fat to obtain an oil phase; and mixing the aqueous phase with the oil phase, followed by emulsification and sterilization to obtain the full-nutrition formula food emulsion for special medical purpose; wherein the minerals comprise sodium, potassium, copper, magnesium, iron, zinc, manganese, calcium, phosphorus, iodine, chlorine, and selenium; the oil-soluble vitamins comprise vitamin A, vitamin D, vitamin E, and vitamin K₁; and the water-soluble vitamins comprise vitamin B₁, vitamin B₂, vitamin B₆, vitamin B₁₂, nicotinic acid, folic acid, pantothenic acid, vitamin C, and biotin.

7. The preparation method for the full-nutrition formula food emulsion for special medical purpose with a vegetable complete protein as sole protein source according to claim 6, wherein a homogenization method comprises one or more of shearing homogenization, ultrasonic homogenization, high-pressure homogenization, and ball milling.

8. The preparation method for the full-nutrition formula food emulsion for special medical purpose with a vegetable complete protein as sole protein source according to claim 6, wherein a pH value of the aqueous phase solution is 6.5-7.5.

9. The preparation method for the full-nutrition formula food emulsion for special medical purpose with a vegetable complete protein as sole protein source according to claim 8, wherein a pH regulation solution used to maintain the pH of the system comprises one or more of edible organic or inorganic acids and salts thereof.

10. The preparation method for the full-nutrition formula food emulsion for special medical purpose with a vegetable complete protein as sole protein source according to claim 6, further comprising separately adding other functional components to the aqueous phase, the oil phase, or the two phases.

11. The preparation method for the full-nutrition formula food emulsion for special medical purpose with a vegetable complete protein as sole protein source according to claim 7, further comprising separately adding other functional components to the aqueous phase, the oil phase, or the two phases.

12. The preparation method for the full-nutrition formula food emulsion for special medical purpose with a vegetable complete protein as sole protein source according to claim 8, further comprising separately adding other functional components to the aqueous phase, the oil phase, or the two phases.

13. The preparation method for the full-nutrition formula food emulsion for special medical purpose with a vegetable complete protein as sole protein source according to claim 9, further comprising separately adding other functional components to the aqueous phase, the oil phase, or the two phases.
